(19) United States
(12) Patent Application Publication
(10) Pub. No.: US 2026/0099688 A1
(43) Pub. Date: Apr. 9, 2026

(54) SYSTEMS AND METHODS FOR PRIORITY PLACEMENT IN MISSING OR DEFECTIVE JET CORRECTION

(71) Applicant: Xerox Corporation, Norwalk, CT (US)

(72) Inventor: Stuart A. Schweid, Pittsford, NY (US)

(21) Appl. No.: 18/907,876

(22) Filed: Oct. 7, 2024

(51) Int. Cl. G06K 15/02; G06K 15/00; G06K 15/10

(52) U.S. Cl. CPC G06K 15/1822; G06K 15/102; G06K 15/408

(57) ABSTRACT

Systems and methods for operating a printing system. The methods comprise: identifying a pixel in a bit map (BM) in which ink drop is to be ejected by inoperative inkjet (the pixel having a first drop value (DV)); identifying other pixels in BM that are to be analyzed in a pixel order defined by a displacement map (each other pixel having a second DV); performing a higher preference action analysis of only first ones of the pixels assigned a given priority level of a plurality of different priority levels defined by a priority map to determine whether a higher preference action (TPA) is allowable based on first and second DVs; and performing a lower preference action analysis of only the first ones of the pixels to determine whether a lower preference action is allowable based on first and second DVs, when a determination is made that HPA is not allowable.

### BACKGROUND

### Description of the Related Art

Drop on demand inkjet technology for producing printed media has been employed in commercial products such as printers, plotters, and facsimile machines. Generally, an inkjet image is formed by selectively ejecting ink drops from a plurality of inkjets, which are arranged in one or more printheads, onto an image receiving surface. In a direct inkjet printer, the printheads eject ink drops directly onto the surface of a print medium such as a paper sheet or a continuous paper web. In an indirect inkjet printer, the printheads eject ink drops onto the surface of an intermediate image receiving member such as a rotating imaging drum or belt. During printing, the printheads and the image receiving surface move relative to one other and the inkjets eject ink drops at appropriate times to form an ink image on the image receiving surface. A controller in the printer generates electrical signals, also known as firing signals, at predetermined times to activate individual inkjets in the printer. The ink ejected from the inkjets can be liquid ink, such as aqueous, solvent, oil based, UV curable ink or the like, which is stored in containers installed in the printer. Alternatively, some inkjet printers use phase change inks that are loaded in a solid form and delivered to a melting device. The melting device heats and melts the solid phase change ink to a liquid form that is supplied to a printhead for printing as liquid drops onto the image receiving surface.

During operation, some inkjets in one or more printheads fail to operate due to contaminants that clog nozzles or due to other malfunctions in the printhead. As used herein, the term “inoperable inkjet” refers to an inkjet that fails to eject ink drops onto the predetermined locations of an image receiving surface in a reliable manner during a printing operation. Inoperable inkjets may fail to eject ink drops entirely, eject drops only intermittently, or eject drops onto incorrect locations on the image receiving surface.

### SUMMARY

The present disclosure concerns implementing systems and methods for operating a printing system. The methods comprise: identifying, by the processor, a pixel in a bit map in which an ink drop is to be ejected by an inoperative inkjet during printing operations, the pixel being associated with a first drop value; identifying, by the processor, other pixels in the bit map that are to be analyzed at the present time in accordance with a pixel order defined by a displacement map, each of the other pixels being associated with a second drop value; performing a higher preference action analysis of only first ones of the plurality of pixels assigned a given priority level of a plurality of different priority levels defined by a priority map to determine whether a higher preference action is allowable based on the first and second drop values; and performing a lower preference action analysis of only the first ones of the plurality of pixels to determine whether a lower preference action is allowable based on the first and second drop values, when a determination is made that higher preference action is not allowable.

The present disclosure also concerns a system, comprising: a processor; and a non-transitory computer-readable medium comprising one or more programming instructions that when executed by the processor, cause the processor to: identify a pixel in a bit map in which an ink drop is to be ejected by an inoperative inkjet during printing operations (the pixel being associated with a first drop value); identify other pixels in the bit map that are to be analyzed at the present time in accordance with a pixel order defined by a displacement map (each of the other pixels being associated with a second drop value); perform a higher preference action analysis of only first ones of the plurality of pixels assigned a given priority level of a plurality of different priority levels defined by a priority map to determine whether a higher preference action is allowable based on the first and second drop values; and perform a lower preference action analysis of only the first ones of the plurality of pixels to determine whether a lower preference action is allowable based on the first and second drop values, when a determination is made that higher preference action is not allowable.

The present disclosure further concerns a system comprising: printheads configured to apply ink marks to a sheet of media; and a processor. The processor is configured to: identify a pixel in a bit map in which an ink drop is to be ejected by an inoperative inkjet of the printheads on the sheet of media during printing operations (the pixel being associated with a first drop value); identify other pixels in the bit map that are to be analyzed at the present time in accordance with a pixel order defined by a displacement map (each of the other pixels being associated with a second drop value); perform a higher preference action analysis of only first ones of the plurality of pixels assigned a given priority level of a plurality of different priority levels defined by a priority map to determine whether a higher preference action is allowable based on the first and second drop values; and perform a lower preference action analysis of only the first ones of the plurality of pixels to determine whether a lower preference action is allowable based on the first and second drop values, when a determination is made that higher preference action is not allowable.

### BRIEF DESCRIPTION OF THE DRAWINGS

The present solution will be described with reference to the following drawing figures, in which like numerals represent like items throughout the figures.

FIG. 1 provides an illustration showing an architecture for an inkjet printer.

FIGS. 2A-2B (collectively referred to as “FIG. 2”) provides illustrations showing operations of a conventional system.

FIGS. 3A-3B (collectively referred to as “FIG. 3”) provides illustrations showing operations of a conventional system.

FIGS. 4A-4B (collectively referred to as “FIG. 4”) provide illustrations that are useful for understanding the present solution.

FIGS. 5A-5I (collectively referred to as “FIG. 5”) provide illustrations that are useful for understanding a a pixel analysis associated with a priority map.

FIGS. 6A-6B (collectively referred to as “FIG. 6”) provide illustrations that are useful for understanding a pixel analysis associated with another priority map.

FIGS. 7A-7D (collectively referred to as “FIG. 7”) provide a flow diagram of another illustrative method for operating a printing device.

FIGS. 8A-8B (collectively referred to as “FIG. 8”) provide a flow diagram of another illustrative method for operating a printing device.

FIG. 9 provides a block diagram of a illustrative architecture for a computing device.

### DETAILED DESCRIPTION

As noted above, some inkjets in one or more printheads fail to operate due to contaminants that clog nozzles or due to other malfunctions in the printhead. Existing compensation methods for inoperable inkjets identify pixel locations in binary halftoned image data that correspond to inoperable inkjets and redistribute the orphan pixels from the inoperable inkjet to neighboring inkjets to reduce the perceptible impact of the inoperable inkjet. However, the hardware and software implementations of prior art printers are not suited for use in printers that eject ink drops of different sizes from two or more arrays of inkjets in a print zone. The term “multi-level” as used here refers to configurations in which a combination of multiple drop sizes form printed images. For example, in a printer that forms images using two different drop sizes, each halftoned pixel has a total of four potential values or levels (e.g. no drops, one small drop, one large drop, or both a small and large drop) instead of the traditional binary image data that only includes two values for drop and no drop.

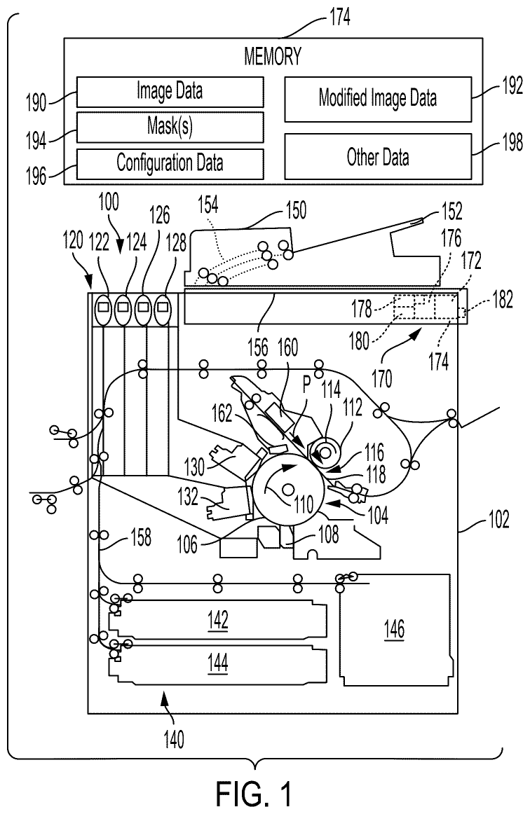

FIG. 1 provides an illustration of an inkjet printer 100. Printer 100 is configured to (i) print images using multiple drop sizes based on multi-bit halftoned image data and (ii) compensate for one or more inoperable inkjets. Printer 100 comprises a frame 102, an image receiving member 104, an actuator 108, and a transfix roller 112. Operating subsystems and components of the printer 100 are mounted directly or indirectly to the frame. The image receiving member 104 is shown in the form of a rotatable imaging drum, but can equally be in the form of a supported endless belt. The image receiving member 104 has an image receiving surface 106, which provides a surface for formation of ink images. Actuator 104 can include, but is not limited to, a servo or electric motor. Actuator 104 engages the image receiving member 104 and is configured to rotate the image receiving member in direction 110. The transfix roller 112 is rotatable in the direction 114 and loads against the surface 106 of drum 104 to form a transfix nip 116 within which ink images formed on the surface 106 are transfixed onto a heated print medium 118.

Printer 100 also comprises a phase change ink delivery subsystem 120 that has multiple sources of different color phase change inks in solid form. Since printer 100 is a multicolor printer, the ink delivery subsystem 120 includes ink sources 122, 124, 126, 128. Each printhead assembly is configured to apply ink of one or more colors. The ink colors include cyan (C), magenta (M), yellow (Y), and black (K). The ink delivery subsystem 120 also includes a melting and control apparatus (not shown) for melting or phase changing the solid form of the phase change ink into a liquid form. Each of the ink sources 122, 124, 126, 128 includes a reservoir used to supply the melted ink to the printhead assemblies 130 and 132.

Printhead assemblies 130 and 132 may receive melted CMYK ink from the ink sources 122-1228, and eject ink drops of one or more sizes. For example, a relatively small ink drop may be ejected from printhead assembly 130, and a relatively large ink drop may be ejected from printhead assembly 132. Alternatively or additionally, ink drops of different sizes may be ejected from inkjet(s) of a single printhead assembly. The image receiving surface is moved past the inkjet(s) for multiple passes to enable ink to be dropped onto the image receiving surface. Multiple ink drops may be applied at individual pixel locations to form composite drops with larger composite drop sizes.

Printer 100 also includes a substrate supply and handling subsystem 140, a document feeder 150, a document sheet feeding and retrieval devices 154, and a document exposure and scanning subsystem 156. Subsystem 140 comprises sheet or substrate supply sources 142, 144, 146. Supply source 146 can include, but is not limited to, a high capacity paper supply or feeder for storing and supplying image receiving substrates in the form of a cut sheet print medium 118. A media transport path 158 extracts print media, such as individually cut media sheets, from the system 140 and moves the print media in a process direction P. The media transport path 158 passes the print medium 118 through a substrate heater or pre-heater assembly 160. Assembly 160 heats the print medium 118 prior to transfixing an ink image to the print medium 118 in the transfix nip 116.

Media sources 142, 144, 146 provide image receiving substrates that pass through media transport path 158 to arrive at transfix nip 116 formed between the image receiving member surface 106 and transfix roller 112 in timed registration with the ink image formed on the image receiving surface 106. As the ink image and media travel through the transfix nip 116, the ink image is transferred from the surface 106 and fixedly fused to the print medium 118 within the transfix nip 116. In a duplexed configuration, the media transport path 158 passes the print medium 118 through the transfix nip 106 a second time for transfixing of a second ink image to a second side of the print medium 118.

Operation and control of the various subsystems, components and functions of the printer 100 are performed with the aid of a controller 170. Controller 170 can include, but is not limited to, a self-contained, dedicated mini-computer having a central processor unit (CPU) 172 with a digital memory 174 and a user interface (UI) 176. Controller 170 may comprise a sensor input and control circuit 178 and an ink drop placement and control circuit 180. Control circuit 180 may be implemented as a field programmable gate array (FPGA). CPU 172 is configured to read, capture, prepare and manage the image data flow associated with print jobs received from image input sources (e.g., scanning system 156) or a remote device via interface 182. Controller 170 is the main multi-tasking processor for operating and controlling all of the other printer subsystems and functions.

Controller 170 can be implemented with general or specialized programmable processors that execute programmed instructions, for example, printhead operation. The instructions and data required to perform the programmed functions are stored in the memory 174. Controller 170 configures the printer 100 to form ink images by controlling the operations of inkjets in the printhead assemblies 132, 134 to compensate for inoperable inkjets.

Memory 174 includes one or more non-volatile data storage devices, such as solid state, magnetic, or optical data storage devices, in addition to volatile memory such as random access memory (RAM). Memory 174 stores various information. This information can include, but is not limited to, image data 190, image data 192 modified to compensate for inoperable inkjets in the printer 100, masks 194 for searching neighboring pixels around an inoperable inkjet, configuration data 196, and other data 198. The other data 198 can include, but is not limited to, instruction(s) and/or look-up tables (LUTs). The LUTs may be configured to facilitate neighboring pixel search and distribution to compensate for pixels that correspond to an inoperable inkjet. Image data 190 can include a two-dimensional array of pixels corresponding to one or more images that the printer 100 forms during a printing operation. Controller 170 can perform a halftoning process that is known to the art to convert a continuous tone (contone) image into a device-specific color space for the printer 100 and generate multi-bit halftoned image data that directly corresponds to the physical arrangement of drops and drop sizes in a final printed image. The modified image data 192 can include additional modifications that the printer 100 performs to the image data 190 to compensate for one or more inoperable inkjets in the printhead assemblies 132 and 134. The masks 194 may be used to omit one or more pixels in a region that neighbors a pixel from an inoperable inkjet during a search process to identify neighboring pixels as adoption sites for a corresponding to the inoperable inkjet.

During operation, the printer 100 ejects a plurality of ink drops from inkjets in the printhead assemblies 132, 134 onto the surface 106 of the image receiving member 104. Controller 170 generates electrical firing signals to operate individual inkjets in one or both of the printhead assemblies 132, 134. Controller 170 processes digital image data corresponding to one or more printed pages in a print job, and generates image data 190 comprising bits maps for each of the CMYK color separations. Each bit map includes a two dimensional arrangement of pixels corresponding to locations on the image receiving member 104. Each pixel can have one or more potential values that indicate (i) whether the pixel is activated or deactivated, and or (ii) which size of ink drop or combination of ink drops should be printed for an activated pixel. Controller 170 generates a firing signal to activate an inkjet and eject a drop of ink onto the image receiving member 104 for the activated pixels, but does not generate a firing signal for the deactivated pixels. The combined bit maps for each of the colors of ink in the printer 100 generate multicolor or monochrome images that are subsequently transfixed to the print medium 116. The controller 170 generates the bit maps with selected activated pixel locations to enable the printer 100 to produce multi-color images, half-toned images, dithered images, and the like.

During a printing operation, one or more of the inkjets in the printhead assemblies 132, 134 may become inoperable. An inoperable inkjet may eject ink drops on an intermittent basis, eject ink drops onto an incorrect location on the image receiving surface 106, or entirely fail to eject ink drops. Printer 100 may comprise an optical sensor 162 configured to generate image data corresponding to the ink drops that are printed on surface 106 after formation of the ink images and prior to the imaging drum 104 rotating through the transfix nip 106 to transfix the ink images. Optical sensor 162 can include, but is not limited to, a linear array of individual optical detectors that detect light reflected from the image receiving surface. Each optical detector may detect an area of the image receiving member corresponding to one pixel on the surface of the image receiving member in a cross-process direction, which is perpendicular to the process direction P. Optical sensor 162 may generate reflectance data corresponding to the light reflected from the image receiving surface. Controller 170 may be configured to identify inoperable inkjets in the printhead assemblies 132, 134 with reference to the reflectance values detected on the imaging receiving surface 106 and the predetermined image data of the printed ink images. Additionally or alternatively, the optical sensor detects defects in ink images after the ink images have been formed on the print medium 116. The inoperable inkjets may be identified with sensors located in the printhead assemblies. In response to identifying an inoperable inkjet, controller 700 may cease generation of firing signals for the inoperable inkjet, and generate firing signals for other inkjets that are proximate the inoperable inkjet in the printer to compensate for the inoperable inkjet.

Most current missing jet algorithms use morphological mapping to move ink jets drops targeted for a defective jet to neighboring jets. This allows for the ink to be printed in close proximity to where it was intended to be placed and to preserve the local ink usage. Several algorithms will use a displacement map that can be either static or dynamic. The dynamic maps can be chosen based upon either previous drop placement movements or a function of current position. TABLE 1 illustrates a displacement map.

TABLE 1
Displacement Map

| | | | | | | |
|---|---|---|---|---|---|---|
| 15 | 9 | 3 | — | 4 | 10 | 16 |
| 13 | 7 | 1 | x | 2 | 8 | 14 |
| 17 | 11 | 5 | — | 6 | 12 | 18 |

The column of TABLE 1 with the x is the column associated with an inoperable inkjet. Numbers 1-18 in TABLE 1 specify an order that the controller 170 uses to identify neighboring pixels as adaption sites for the inoperable inkjet. The displacement map of TABLE 1 has a left bias such that a drop associated with an inoperable inkjet will be moved in preference to operable inkjets on the left of the inoperable inkjet. The lowest number location associated with a deactivated drop will be identified as an adaption location. A value for a corresponding pixel in the bit map will be modified to now indicate that the pixel is activated.

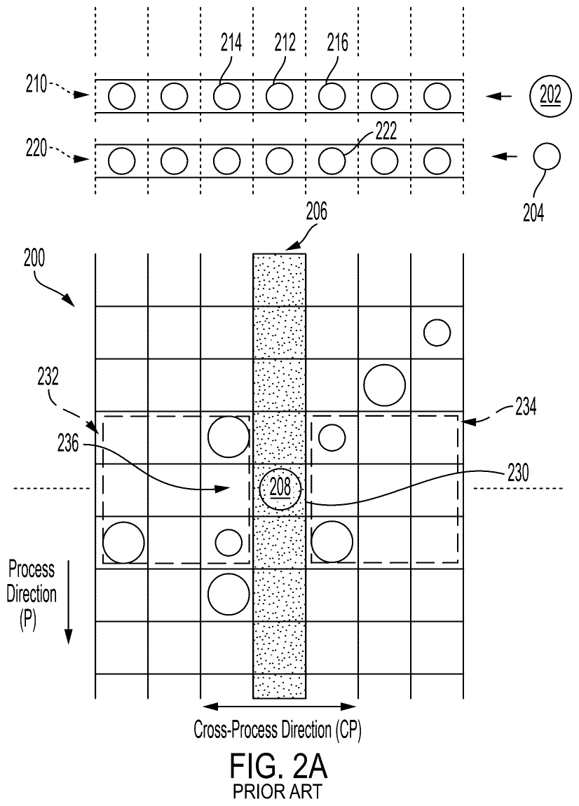

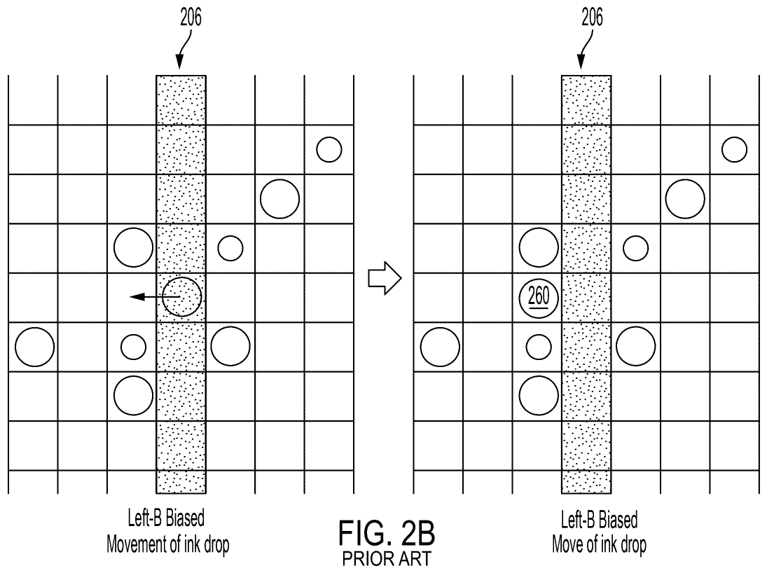

For example, as shown in FIG. 2A, the system comprises inkjets 210, 220. Inkjets 210 are arranged such that the printheads eject medium sized ink drops 202. Inkjets 220 are arranged such that the printheads eject small ink drops 204. The system is not limited to this inkjet arrangement. In other scenarios, the system comprises inkjet 210 and not inkjets 220, where inkjets 210 are each configured to eject small, medium and/or large dots.

Inkjets 214, 216 are operable. Inkjet 212 is inoperable. Thus, a medium sizes drop 208 in pixel column 206 of the original bit map 200 cannot be applied at pixel location 230 to a sheet of media since inoperable inkjet 212 cannot eject ink during the printing operation. Therefore, the controller performs an ordered search process in a predetermined region of pixels that surround the identified pixel 230 to identify neighboring pixel(s) that may serve as an adoption site for the pixel 230. The predetermined region includes 18 pixels arranged in a 3 row by 3 column grid 232, 234 on either side of the pixel column 206 in a cross-process direction CP. During the ordered search, the controller analyzes whether or not ink drops are to be applied at pixel locations in the predetermined region 232, 234 of bit map 200 in the order specified by the displacement map of TABLE 1. As seen in FIG. 2A, no ink drop is to be applied in pixel location 236 associated with cell 1 of the displacement map. Since inkjet 214 is operable, the system selects neighboring pixel 236 as an adoption site for pixel 230. The controller then updates that bit map to move the medium ink drop 208 to the left to pixel location 236 as shown in FIG. 2B.

In a dynamic mode, TABLE 1 may be used in conjunction with another displacement map of TABLE 2 having a right bias. Using both displacement maps results in ink drops being repositioned equally to the left and right of an ink drop associated with the inoperative inkjet.

TABLE 2
Displacement Map

| | | | | | | |
|---|---|---|---|---|---|---|
| 16 | 0 | 4 | — | 3 | 9 | 15 |
| 14 | 8 | 2 | x | 1 | 7 | 13 |
| 18 | 12 | 6 | — | 5 | 11 | 17 |

In the case of multi-drop inkjets (i.e., in which inkjets fire more than one drop size), there are algorithms that perform the compensation through multiple stages for simplicity. For example, a first compensation pass may move only large drops to neighbor pixels where a subsequent compensation will move the medium drops and then small drops. The first stage, for example, may swap large drops assigned to the inoperable inkjet with a medium drop assigned to a neighboring functional inkjet. The multi-stage nature of the algorithm ensures that the medium drop assigned to the inoperable inkjet will later be repositioned to a new location in a subsequent stage.

In the multi-stage case, logic can be used to swap drop values. For example, a medium drop 260 can be swapped with a small drop. Other modifications can be made, such as replacing a small drop of the inoperable inkjet with a non-fire, and replacing a small drop of a neighboring operable inkjet with a large drop. These algorithms still use a standard distribution map similar to that shown in TABLE 1. At each stage of a multi-stage correction, a rule is typically set for what drop sizes to correct for and what drop sizes in the neighborhood constitutes a match. For example, one stage may look for defective drops firing a large drop and neighbors firing either small or no drop. Next, an action is also defined, for example swap defective and neighbor drop vales. Other possible actions include promoting a neighbor (i.e., to the next larger drop), demoting the defective drop (e.g., to the next smallest drop), or assigning a fixed drop value to the defective drop and neighbor drop.

A problem arises with some combinations of corrections because some corrections are preferable if they are closer, but not if they are further away. This limitation means those conditions cannot be addressed by the multi-stage approach, as each stage will correct over the complete displacement map.

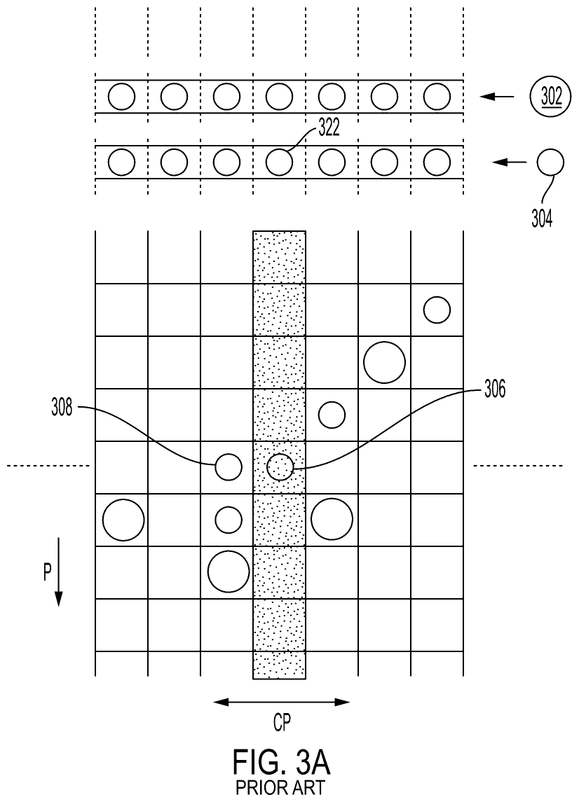

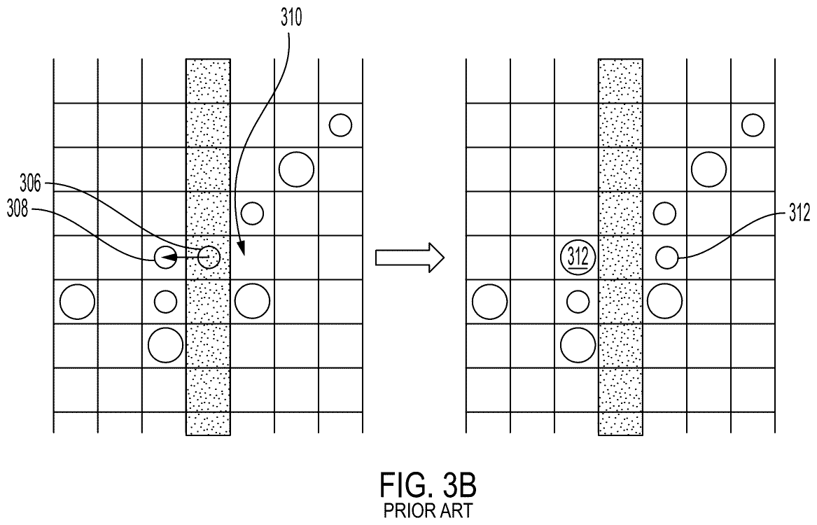

An example of this problem can be seen in FIG. 3. Consider a system that has two possible drop sizes (e.g., a small drop size 304 and a large drop size 302), and an inoperable or defective inkjet 322 is firing a small drop 306. A stage may be created that will demote the defective drop (i.e., the small drop 306 is demoted to none) and promote a selected neighboring drop (e.g., promote a neighboring small drop 308 to a large drop 312 or promote none to a small drop (e.g., promote none 310 to a small drop 312). The correction would be most accurate if the neighbor drop were to promote a non-firing inkjet as the number of small and large drops would not change.

TABLE 3 below shows an original sample bit map. TABLE 4 shows the result of promotion and/or demotion using the displacement map of TABLE 1. TABLE 5 shows the desired output. The value of x is “don't care” and changed values are shown in bold and italicized font. A value of zero refers to no drop or none condition. A value of 1 refers to a small drop condition, while a value of 2 refers to a large drop condition.

TABLE 3
Original Sample Bit Map

| | | | | | | |
|---|---|---|---|---|---|---|
| x | x | x | x | x | x | x |
| x | x | 1 | 1 | 0 | x | x |
| x | x | x | x | x | x | x |

TABLE 4
Result of Correction

| | | | | | | |
|---|---|---|---|---|---|---|
| x | x | x | x | x | x | x |
| x | x | 2 | 0 | 0 | x | x |
| x | x | x | x | x | x | x |

TABLE 5
Desired Correction

| | | | | | | |
|---|---|---|---|---|---|---|
| x | x | x | x | x | x | x |
| x | x | 1 | 0 | 1 | x | x |
| x | x | x | x | x | x | x |

This result could be avoided by doing the stages differently. Such as by first doing a swap of a small drop with none followed by a stage that does promotion and/or demotion. This results in undesired results when the swap occurs with pixels far away.

TABLE 6 below shows an example of a sample original bit map. TABLE 7 shows the result of using swapping a small drop with none with the displacement map in TABLE 1. TABLE 8 shows a desired output. The value of x is “don't care” and changed values are shown in bold and italicized font. A value of zero refers to no drop or none condition. A value of 1 refers to a small drop condition, while a value of 2 refers to a large drop condition.

TABLE 6
Original Sample Bit Map

| | | | | | | |
|---|---|---|---|---|---|---|
| 0 | 1 | 1 | x | 1 | 1 | x |
| 1 | 1 | 1 | 1 | 1 | 1 | 1 |
| x | 1 | 1 | x | 1 | 1 | x |

TABLE 7
Result of Correction

| | | | | | | |
|---|---|---|---|---|---|---|
| 1 | 1 | 1 | x | 1 | 1 | x |
| 1 | 1 | 1 | 0 | 1 | 1 | 1 |
| x | x | 1 | x | 1 | 1 | x |

TABLE 8
Desired Correction

| | | | | | | | |
|---|---|---|---|---|---|---|---|
| 0 | 1 | 1 | 1 | x | 1 | 1 | x |
| 1 | 1 | 1 | 2 | 0 | 1 | 1 | 1 |
| x | x | 1 | 1 | x | 1 | 1 | x |

In this case, the proximity is more important than the preservation of the original drop types. This is different than the example shown in TABLES 3-5, where proximity didn't vary.

The current art of missing inkjet correction using a multi-stage paradigm allows precedence of what kinds of corrections happen at each stage, so priority can be given to certain types of modifications in lieu of other types. It also allows two types of modifications to be given equal weighting (in a single stage) through its rules. It does not, however, allow two modifications to be unequal priority at equivalent distances but equal priority otherwise.

To allow priority of one type of correction over another within a single stage correction, a priority map is introduced. Below is an example of two priority maps. TABLE 9 shows a priority map A in which priority is given based on inkjet distance (i.e., a cross process distance). TABLE 10 shows a priority map in which priority is given based upon pixel distance. A value of 1 in priority maps A and B is associated with a highest priority. A value of 3 in priority map A is associated with a lowest priority, while a value of 6 in priority map B is associated with the lowest priority.

TABLE 9
Priority Map A

| | | | | | | |
|---|---|---|---|---|---|---|
| 3 | 2 | 1 | — | 1 | 2 | 3 |
| 3 | 2 | 1 | — | 1 | 2 | 3 |
| 3 | 2 | 1 | — | 1 | 2 | 3 |

TABLE 10
Priority Map B

| | | | | | | |
|---|---|---|---|---|---|---|
| 6 | 4 | 2 | — | 2 | 4 | 6 |
| 5 | 3 | 1 | — | 1 | 3 | 5 |
| 6 | 4 | 2 | — | 2 | 4 | 6 |

The system may be configured to, for example: (1) promote none to a small drop at priority 1 pixel locations in the predetermined regions of the bit map; (2) promote a small drop to a large drop at priority 1 pixel locations in the predetermined regions of the bit map; (3) promote none to a small drop at priority 2 pixel locations in the predetermined regions of the bit map; (4) promote a small drop to a large drop at priority 2 pixel locations in the predetermined regions of the bit map; (4) promote none to a small drop at priority 3 pixel locations in the predetermined regions; and (5) promote a small drop to a large drop at priority 3 pixel locations in the predetermined regions of the bit map, and so on.

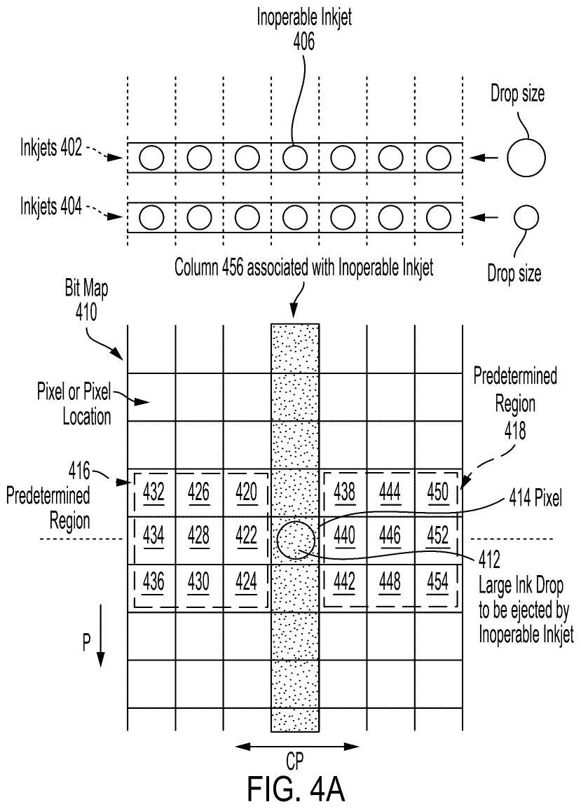

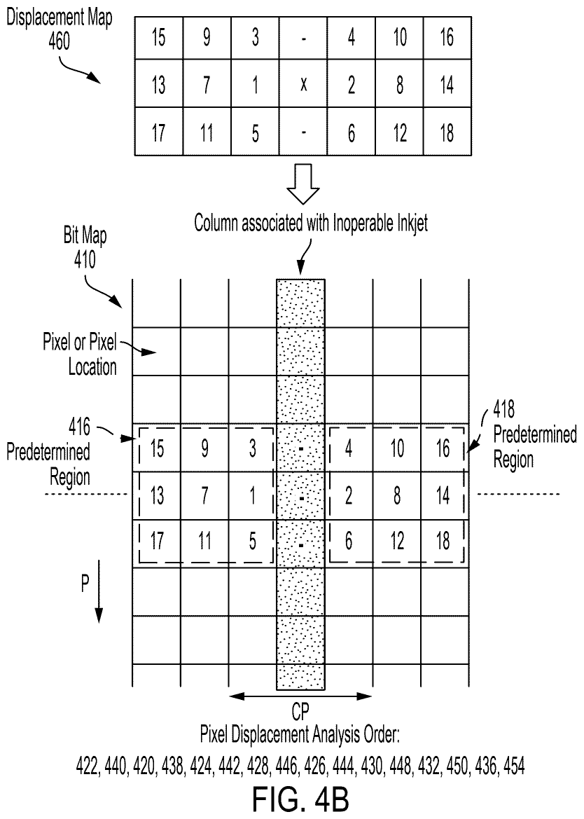

FIG. 4 provides an illustration that is useful for understanding operations of a system when implementing the displacement map of TABLE 1 and the priority map A of TABLE 9 or priority map B of TABLE 10. As shown in FIG. 4, the system comprises inkjets 402, 404. Inkjets 402 are configured to eject large drops, while inkjets are configured to eject small drops. The system is not limited to this inkjet arrangement. In other scenarios, the system comprises inkjet 402 and not inkjets 404, where inkjets 402 are each configured to eject small, medium and/or large dots. As shown in FIG. 4A, inkjet 406 is inoperable, while all other inkjets are operable.

Bit map 410 indicates that the inoperable inkjet 406 is to eject a large ink drop 412 at pixel location 414 on a sheet of media during a print job. Because inkjet 406 is inoperable, controller 170 performs an analysis of drop values for pixels 420-454 in predetermined regions 416, 418 in accordance with both a displacement map 460 and the priority map A or B. Displacement map 460 is shown as comprising the displacement map of TABLE 1. The present solution is not limited in this regard. Other displacement maps can be used without limitation. In accordance with displacement map 460, the pixel displacement analysis order is 422, 440, 420, 438, 424, 442, 428, 446, 426, 444, 430, 448, 432, 450, 436, 454.

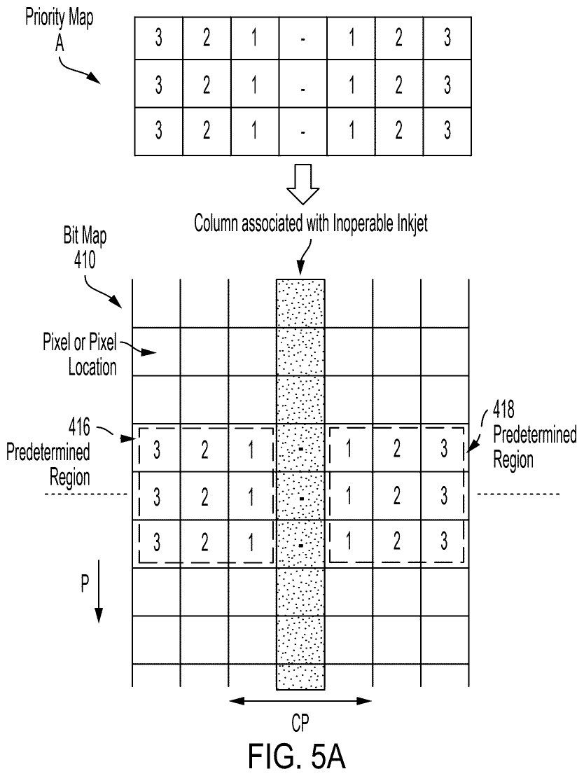

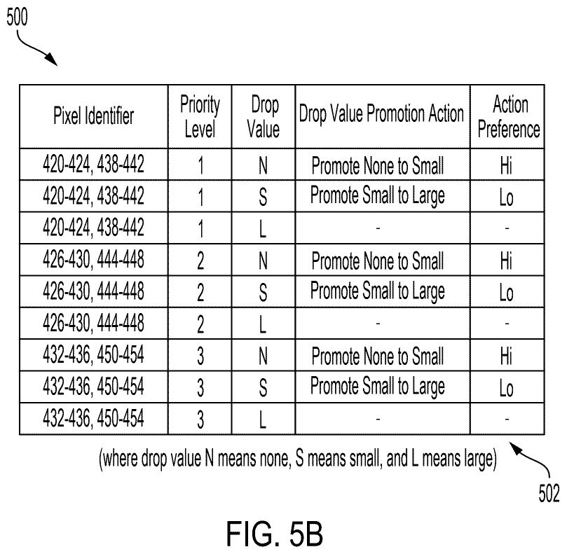

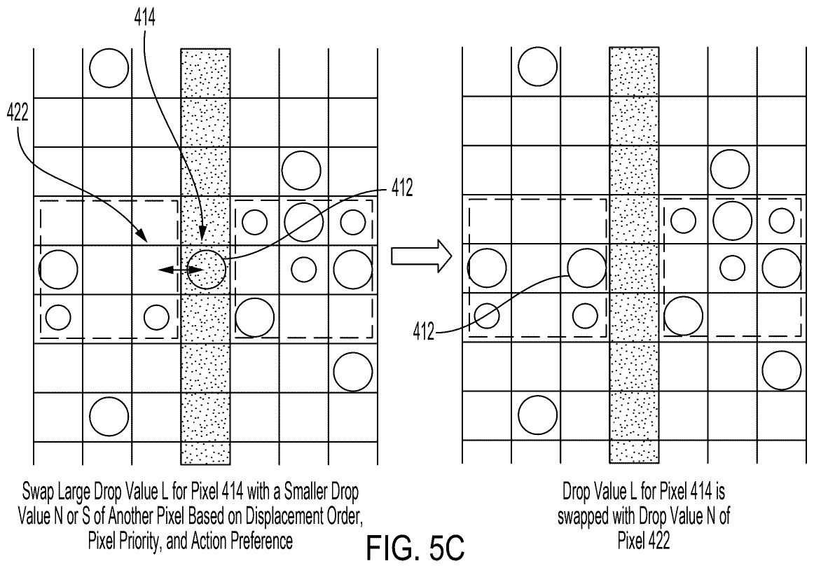

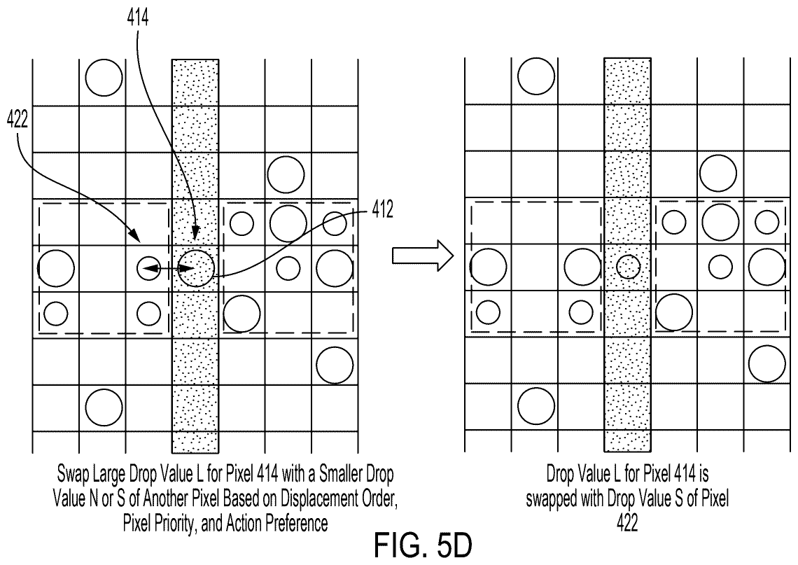

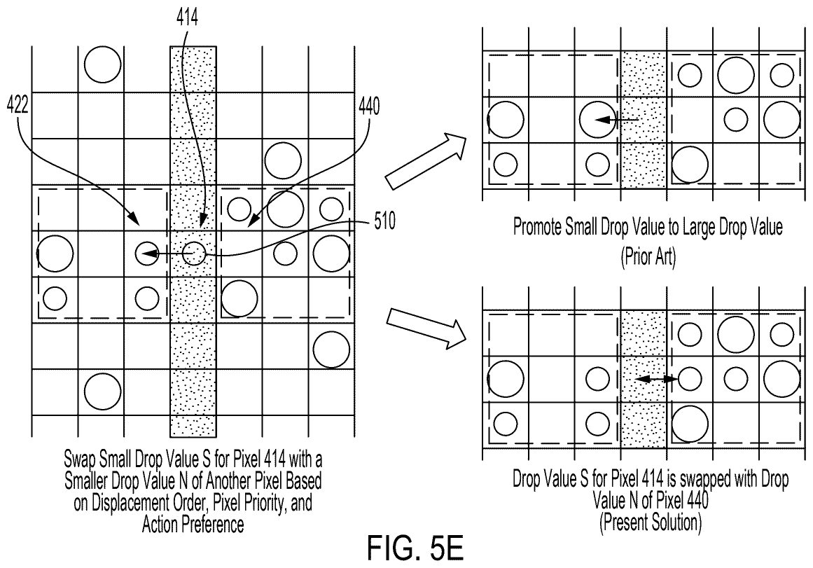

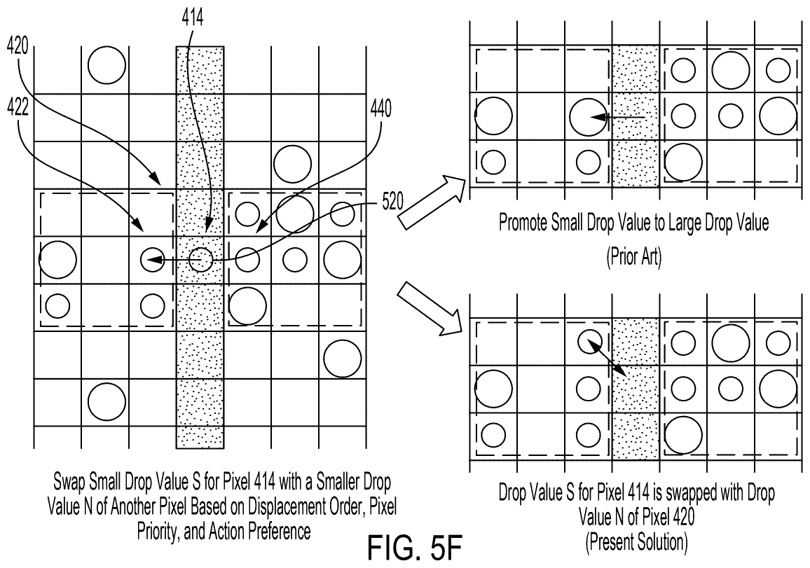

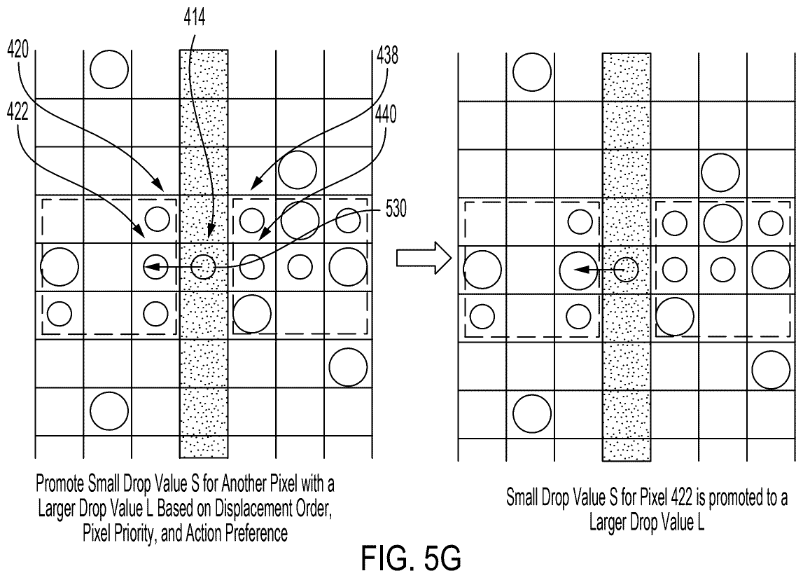

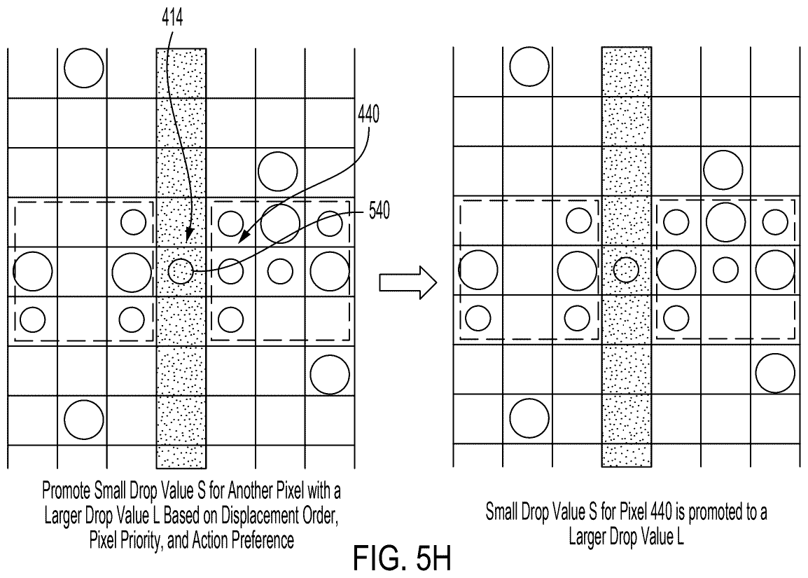

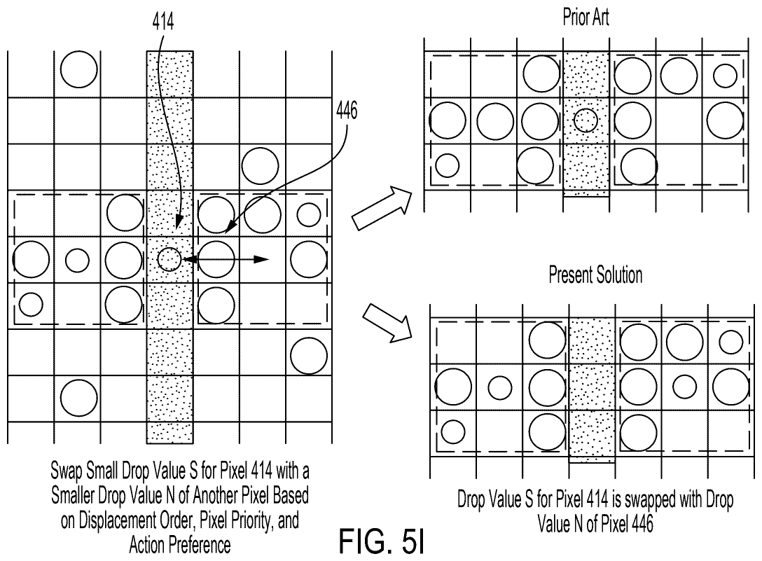

The analysis associated with priority map A will be discussed in relation to FIG. 5. In accordance with priority map A, the pixels assigned a priority level of 1 are 420-424 and 438-442. The pixels assigned a priority level of 2 are 426-430 and 444-448. The pixels assigned a priority level of 3 are 432-436 and 450-454.

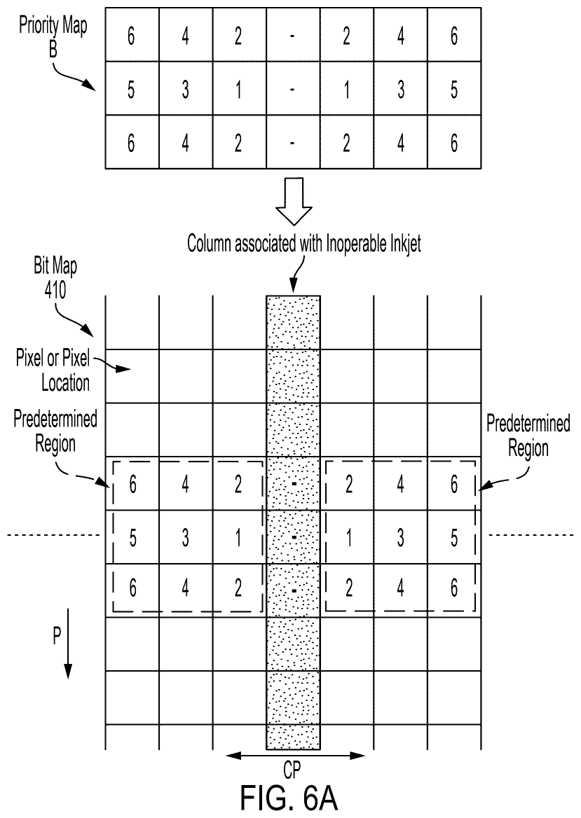

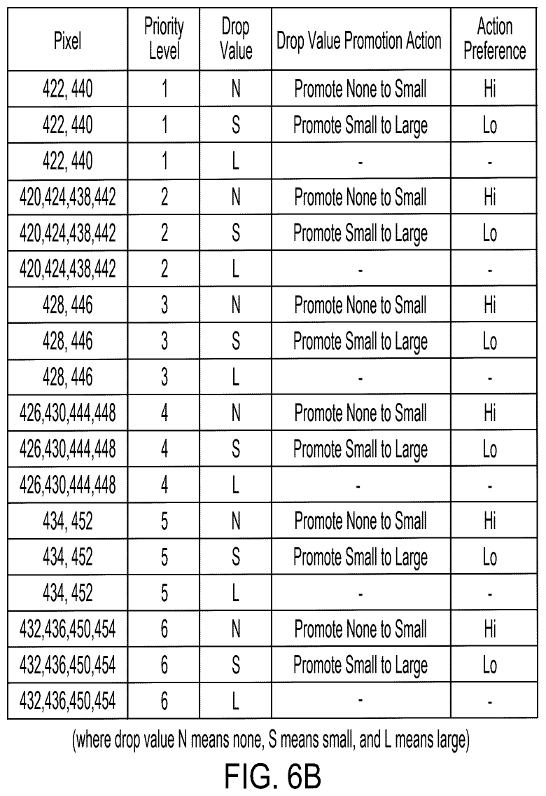

The analysis associated with priority map B will be discussed in relation to FIG. 6. In accordance with priority map B, the pixels assigned a priority level of 1 are 422 and 440. Pixels assigned a priority level of 2 are 420, 424, 438 and 442. Pixels assigned a priority level of 3 are 428 and 446. Pixels assigned a priority level of 4 are 426, 430, 444 and 448. Pixels assigned a priority level of 5 are 434 and 452. Pixels assigned a priority level of 6 are 432, 436, 450 and 454.

In both priority map A and B cases, the system generally performs an ordered analysis of the pixels assigned a priority level of 1 to determine whether an action of a high preference (e.g., promote none to small) is possible. If not, then the system performs an ordered analysis of the pixels assigned a priority level of 2 to determine whether an action of low preference (e.g., promote small to large) is possible. If not, then the system performs an ordered analysis of the pixels assigned a priority level of 2 to determine whether an action of a high preference (e.g., promote none to small) is possible. If not, then the system performs an ordered analysis of the pixels assigned a priority level of 2 to determine whether an action of low preference (e.g., promote small to large) is possible. If not, then the system performs an ordered analysis of the pixels assigned a priority level of 3 to determine whether an action of a high preference (e.g., promote none to small) is possible. If not, then the system performs an ordered analysis of the pixels assigned a priority level of 3 to determine whether an action of low preference (e.g., promote small to large) is possible. Similar operations may be performed for other lesser priority levels. The details of these operations will become evident as the discussion progresses.

As shown in FIGS. 5A-5B, pixels 420-424 have a priority of 1. Pixels 426-430 have a priority of 2, while pixels 432-436 have a priority of 3. The analysis involves selectively modifying drop values for the pixels based on their displacement order, priorities, and action preferences. A drop value of N means that no drop is to be ejected by an inkjet, and may be promoted or otherwise changed by the controller to a drop value of S. A drop value of S means that a small drop is to be ejected by an inkjet. A drop value of S may be promoted or otherwise changed by the controller to a drop value of L. A drop value of L means that a large drop is to be ejected by an inkjet. Since L represents the largest possible drop size, promotion of the drop value L to an even larger drop value is not possible. Thus, no action is associated with the drop value L. The system is configured such that a promotion from none to small has a higher preference than a promotion from small to large. In this regard and as seen in table 500 of FIG. 5B, an action preference of Hi is assigned to actions for promoting a drop value of none to small, while an action preference of Lo is assigned to actions for promoting a drop value of small to large. This significance of the action preferences will become evident as the discussion progresses. Table 500 may be implemented in the system as an LUT and/or rule(s).

Operations of the system in different scenarios will be described in relation to FIGS. 5C-5I. In the scenario shown in FIG. 5C, the inoperable inkjet 406 is to eject a large ink drop 412 during printing operations. The system performs operations to swap a drop value L for pixel 414 with a drop value N or S of another pixel. The identification of the another pixel for the drop value swap is made based on the displacement order defined by displacement map 460 of FIG. 4B, the priority map A of FIG. 5A, and the action preferences 502 of FIG. 5B.

Accordingly, the system performs the following operations prior to performance of a print job: (i) detecting an inoperative inkjet 412; (ii) identifying a column 456 in a bit map 410 that is associated with the inoperative inkjet 406; (iii) identifying a pixel 414 in the column 456 in which an ink drop 412 is to be ejected by the inoperative inkjet 406; (iv) obtaining a drop value L for the ink drop 412; (v) identifying a pixel 422 in the bit map 410 that is to be analyzed first as specified by the displacement map 460; (vi) obtaining a drop value N for the identified first pixel 422; (vii) comparing the drop values to each other to determine if a drop size for pixel 414 is larger than a drop size for pixel 422; and (viii) swapping the drop value L for pixel 414 with the drop value N for the first pixel 422 when a determination is made that the drop size for ink drop 412 is larger than the drop size for pixel 422.

In the scenario of FIG. 5D, the inoperable inkjet 406 is to eject a large ink drop 412 during printing operations. The system performs operations to swap a drop value L for pixel 414 with a drop value N or S of another pixel. The identification of the another pixel for the drop value swap is made based on the displacement order defined by displacement map 460 of FIG. 4B, the priority map A of FIG. 5A, and the action preferences 502 of FIG. 5B.

Accordingly, the system performs the following operations prior to performance of a print job: (i) detecting an inoperative inkjet 412; (ii) identifying a column 456 in a bit map 410 that is associated with the inoperative inkjet 406; (iii) identifying a pixel 414 in the column 456 in which an ink drop 412 is to be ejected by the inoperative inkjet 406; (iv) obtaining a drop value L for the ink drop 412; (v) identifying a pixel 422 in the bit map 410 that is to be analyzed first as specified by the displacement map 460; (vi) obtaining a drop value S for the identified first pixel 422; (vii) comparing the drop values to each other to determine if a drop size for pixel 414 is larger than a drop size for pixel 422; and (viii) swapping the drop value L for pixel 414 with the drop value S for the first pixel 422 when a determination is made that the drop size for ink drop 412 is larger than the drop size for pixel 422.

In the scenario of FIG. 5E, the inoperable inkjet 406 is to eject a small ink drop 510 during printing operations. The system performs operations to swap a small drop value S for pixel 414 with a smaller drop value N of another pixel. The identification of the another pixel for the drop value swap is made based on the displacement order defined by displacement map 460 of FIG. 4B, the priority map A of FIG. 5A, and the action preferences 502 of FIG. 5B.

Accordingly, the system performs the following operations prior to performance of a print job: (i) detecting an inoperative inkjet 412; (ii) identifying a column 456 in a bit map 410 that is associated with the inoperative inkjet 406; (iii) identifying a pixel 414 in the column 456 in which an ink drop 510 is to be ejected by the inoperative inkjet 406; (iv) obtaining a drop value S for the ink drop 510; (v) identifying a pixel 422 in the bit map 410 that is to be analyzed first as specified by the displacement map 460; (vi) obtaining a drop value S for the identified first pixel 422; and (vii) comparing the drop values to each other to determine if they are the same. If the drop values are the same, then the system continues with the following operations: (viii) identifying a pixel 440 in the bit map 410 that is to be analyzed second as specified by the displacement map 460; (ix) obtaining a drop value N for the identified second pixel 440; (x) comparing the drop values to each other to determine if a drop size for pixel 414 is larger than the drop size for pixel 440; and (xi) swapping the drop value S for pixel 414 with the drop value N for the second pixel 440.

The result of these operations is different than that of prior art systems. In prior art systems, the large drop value L of pixel 414 would be set to a drop value N, and the small drop value S of pixel 422 would be replaced with a large drop value L, as shown in FIG. 5E.

In the scenario of FIG. 5F, the inoperable inkjet 406 is to eject a small ink drop 520 during printing operations. The system performs operations to swap a small drop value S for pixel 414 with a smaller drop value N of another pixel. The identification of the another pixel for the drop value swap is made based on the displacement order defined by displacement map 460 of FIG. 4B, the priority map A of FIG. 5A, and the action preferences 502 of FIG. 5B.

Accordingly, the system performs the following operations prior to performance of a print job: (i) detecting an inoperative inkjet 412; (ii) identifying a column 456 in a bit map 410 that is associated with the inoperative inkjet 406; (iii) identifying a pixel 414 in the column 456 in which an ink drop 520 is to be ejected by the inoperative inkjet 406; (iv) obtaining a drop value S for the ink drop 520; (v) identifying a pixel 422 in the bit map 410 that is to be analyzed first as specified by the displacement map 460; (vi) obtaining a drop value S for the identified first pixel 422; and (vii) comparing the drop values to each other to determine if they are the same. If the drop values are the same, then the system continues with the following operations: (viii) identifying a pixel 440 in the bit map 410 that is to be analyzed second as specified by the displacement map 460; (ix) obtaining a drop value S for the identified second pixel 440; and (x) comparing the drop values to each other to determine if a drop size for pixel 414 is the same as the drop size for pixel 440.

If the drop values are the same, then the continues with the following operations: (xi) identifying a pixel 420 in the bit map 410 that is to be analyzed third as specified by the displacement map 460; (xii) obtaining a drop value N for the identified second pixel 420; and (xiii) comparing the drop values to each other to determine if a drop size for pixel 414 is the same as the drop size for pixel 420; and (iv) swapping the drop value S for pixel 414 with the drop value N for the second pixel 420 when the drop size for pixel 414 is larger than the drop size for pixel 420.

The result of these operations is different than that of prior art systems. In prior art systems, the large drop value L of pixel 414 would be set to a drop value N, and the small drop value S of pixel 422 would be replaced with a large drop value L, as shown in FIG. 5F.

In the scenario of FIG. 5G, the inoperable inkjet 406 is to eject a small ink drop 530 during printing operations. The system performs operations to promote a small drop value S for another pixel 414 with a large drop value L. The identification of the another pixel for the drop value promotion is made based on the displacement order defined by displacement map 460 of FIG. 4B, the priority map A of FIG. 5A, and the action preferences 502 of FIG. 5B.

Accordingly, the system performs the following operations prior to performance of a print job: (i) detecting an inoperative inkjet 412; (ii) identifying a column 456 in a bit map 410 that is associated with the inoperative inkjet 406; (iii) identifying a pixel 414 in the column 456 in which an ink drop 530 is to be ejected by the inoperative inkjet 406; (iv) obtaining a drop value S for the ink drop 530; (v) identifying a pixel 422 in the bit map 410 that is to be analyzed first as specified by the displacement map 460; (vi) obtaining a drop value S for the identified first pixel 422; and (vii) comparing the drop values to each other to determine if they are the same or if the drop size specified by the drop value for pixel 414 is larger than the drop size specified by the drop value for pixel 422.

If the drop values are the same, then the system continues with the following operations: (viii) identifying a pixel 440 in the bit map 410 that is to be analyzed second as specified by the displacement map 460; (ix) obtaining a drop value S for the identified second pixel 440; and (x) comparing the drop values to each other to determine if they are same or if the drop size specified by the drop value for pixel 414 is larger than the drop size specified by the drop value for pixel 440.

If the drop values for pixels 414 and 440 are the same, then the system repeats operations (viii)-(x) for next pixel 420 having a same assigned priority level (e.g., 1) in accordance with the order specified by the displacement map 460. When the drop values for pixels 414, 420 are the same, the system repeats operations (viii)-(x) for the next pixel 438 in the specified order which has the same assigned priority level (e.g., 1). When the drop values for pixels 414 and 438 are the same as shown in FIG. 5G, the system repeats operations (viii)-(x) for the next pixel 424 in the specified order which has the same assigned priority level (e.g., 1). When the drop values for pixels 414 and 424 are the same as shown, the system repeats operations (viii)-(x) for the next pixel 442 in the specified order which has the same assigned priority level (e.g., 1). In the scenario shown in FIG. 5G, the drop size associated with pixel 414 is smaller than the drop size associated with pixel 442, thus no action is to be taken.

Since the drop size associated with pixel 414 is the same as the drop sizes associated with pixels 420-424, 438, 440 and smaller than the drop size associated with pixel 442, the system begins a second iteration of the analysis for these pixels with the same priority level (e.g., priority level 1). This is due to the fact that the drop values of pixels 420-424 and 438-442 do not allow for the high preference action to promote a drop value N to a drop value S. So, the system continues with further operations to determine whether the drop values of pixels 420-424 and 438-442 allow for the low preference action to promote a drop value S to a drop value L. As can be seen in FIG. 5G, the drop value S for pixel 422 allows for the low preference action. Consequently, the system performs operations to promote the drop value S for pixel 422 to a drop value L.

In the scenario of FIG. 5H, the inoperable inkjet 406 is to eject a small ink drop 540 during printing operations. The system performs operations to promote a small drop value S for another pixel 414 with a large drop value L. The identification of the another pixel for the drop value promotion is made based on the displacement order defined by displacement map 460 of FIG. 4B, the priority map A of FIG. 5A, and the action preferences 502 of FIG. 5B. These operations are similar to those discussed above in relation to FIG. 5G. As can be seen in FIG. 5H, the drop value S for pixel 440 is promoted to a drop value L.

In the scenario of FIG. 5I, the inoperable inkjet 406 is to eject a small ink drop 540 during printing operations. The system performs operations to swap a small drop value S for pixel 414 with a drop value N associated with another pixel. The identification of the another pixel for the drop value swap is made based on the displacement order defined by displacement map 460 of FIG. 4B, the priority map A of FIG. 5A, and the action preferences 502 of FIG. 5B. These operations are similar to those discussed above in relation to FIG. 5G. As can be seen in FIG. 5I, the drop value S for pixel 440 is swapped to a drop value N associated with pixel 446 having a priority level of 2. This is due to the facts that (1) the drop sizes associated with all of the priority level 1 pixels 420-424, 438-442 are larger than the drop size associated with pixel 414, and (2) the high preference action is to promote a drop size N to a drop size S.

FIG. 6 provides illustrations that are useful for understanding the operations of the system when a different priority map B is employed. These operations are the similar to those described above in relation to FIG. 5. However, in this case, only two pixel are assigned each priority level rather than four pixels. This results in a total of six priority levels rather than a total of three priority levels.

As evident from FIGS. 5-6, precedence can be given for one type of replacement using the priority map in the case where multiple replacements can occur (e.g., the promotion and/or demotion). For example, the promotion and/or demotion has two possible actions as seen above. These possible action include (i) demote a small defective drop to off and promote an unused neighbor drop to small, and (ii) demote a small defective drop to off and promote a small neighbor drop to large. In this example, promoting an unused neighbor drop to small takes precedence over promoting a small neighbor drop to a large drop for the aforementioned reasons.

The priority algorithm will search for all cases of both types of promotions (off to small, small to large) exclusively in the locations labeled as priority 1 (1 being the highest priority) in the priority map. If both types of promotions exist, then the algorithm will choose the promotion of an unused neighbor to a small drop, as this takes precedence. This will be true even if the location of where this occurs corresponds to a higher value in the displacement map than the other type of correction (small to large). This is one key instance where the new proposed method differs from the current art. If more than one of the higher precedent mappings occurs, then the one with the lowest corresponding displacement map value will be selected.

If only lower precedent corrections (small to large in the example) are available in locations with priority 1, then the algorithm will choose that correction type and terminate. If more than one of the lower precedent corrections occur, then the one with the lowest corresponding displacement map value will be selected.

If neither type of correction is available in the locations marked as priority 1, then the algorithm will continue by examining the locations labeled as priority 2 in the priority map. The steps and decisions within that priority level are identical to the logic described above for the priority 1 case. If no correction can be made in the second priority stage, then the process is repeated until all priority stages are completed.

The present solution has many advantages. These advantages can include, but are not limited to: (1) a priority map extends the current missing jet correction stage to segment the displacement map into ordered groupings of search; (2) multiple replacement types compete with different precedence within a given priority level, but not across priority levels; (3) tradeoffs can be made between the importance of location selection and drop replacement type as a joint optimization instead of just sequentially; and (4) the algorithm is completely backward compatible to the current art by setting the priority map to a constant value.

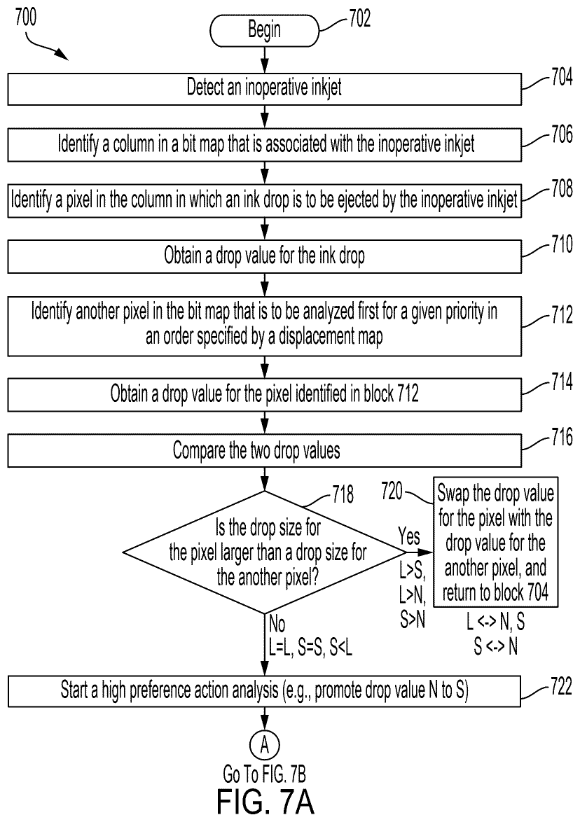

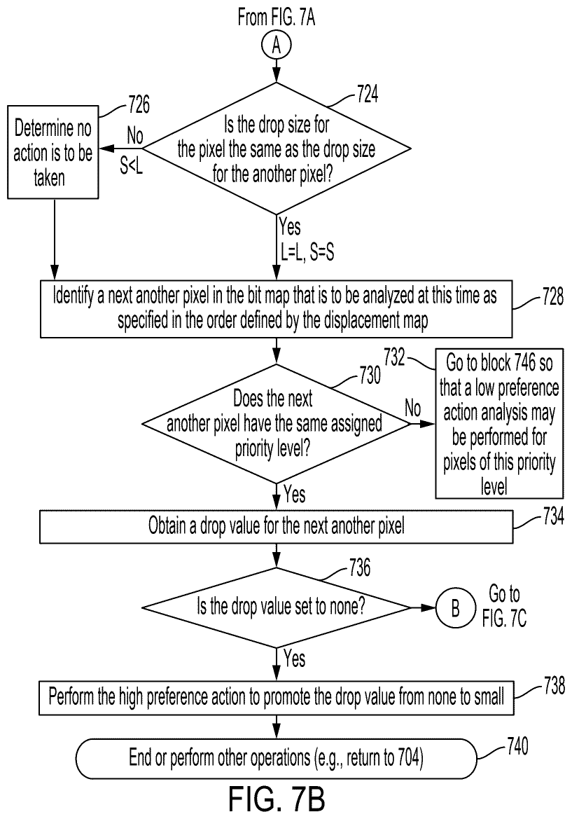

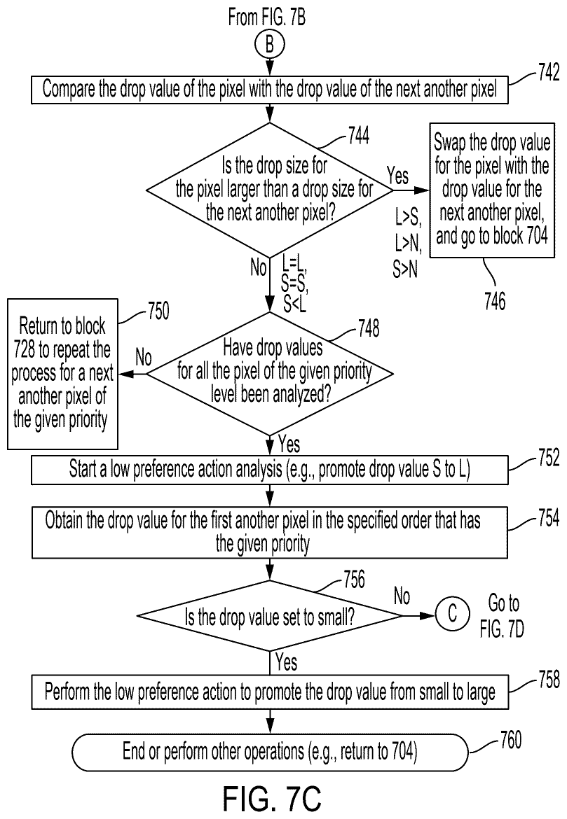

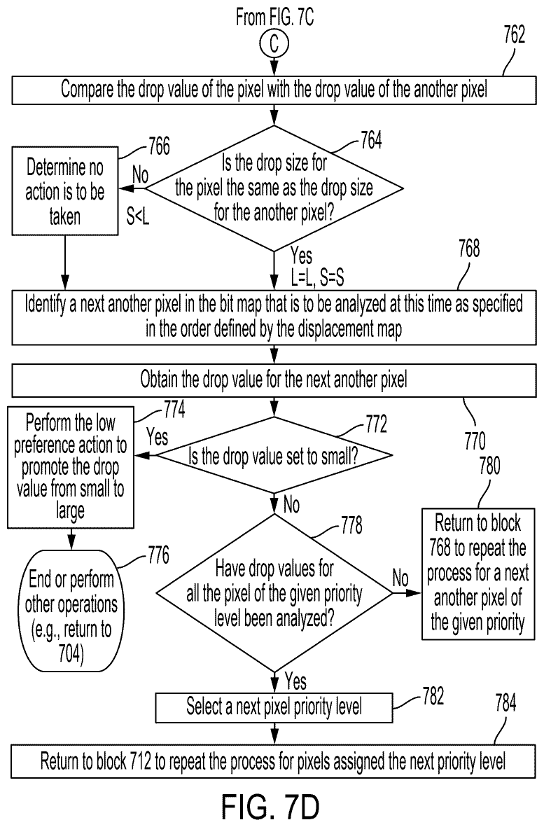

FIG. 7 provides a flow diagram of an illustrative method 700 for operating a system (e.g., system 100 of FIG. 1). The operations of the blocks in FIG. 7 may be performed in the same or different order than the order shown, and/or may include more or less operations than that shown.

Method 700 begins with 702 and continues to optional block 704 in which the system detects an inoperative inject (e.g., inkjet 406 of FIG. 4). Any known or to be known techniques for detecting inoperative inkjets can be used here. Next in blocks 706-708, the system (i) identifies a column (e.g., column 456 of FIG. 4) in a bit map (e.g., but map 410 of FIG. 4) that is associated with the inoperative inkjet and (ii) identifies a pixel (e.g., pixel 414 of FIG. 4) in the column in which an ink drop (e.g., ink drop 412 of FIG. 4) is to be ejected by the inoperative inkjet. A drop value for the ink drop is obtained in block 710. For example, the drop value can be S indicating a relatively smaller drop size or L indicating a relatively larger drop size. The present solution is not limited in this regard. Other drop values can be used in accordance with any given application.

In block 712, the system performs operations to identify another pixel (e.g., pixel 422 of FIG. 4) in the bit map that is be analyzed first for a given priority level (e.g., priority level 1) in an order specified by a displacement map (e.g., displacement map 460 of FIG. 4). The drop value for the another pixel is obtained by the system as shown by block 714.

The two drop values obtained in blocks 710, 714 are compared to each other in block 716. If the drop size for the pixel associated with the inoperative inkjet is larger than a drop size for the another pixel [718:YES], then method 700 continues to block 720 where the drop value for the pixel is swapped with the drop value for the another pixel. Method 700 then returns to block 704.

If the drop size for the pixel associated with the inoperative inkjet is not larger than a drop size for the another pixel [718:NO], then method 700 continues to block 722 where the system starts or otherwise begins a high preference action analysis. The high preference action analysis can generally involve promoting a drop value N to S for one of the pixels with the given priority level assigned thereto. The operations of the high preference action analysis will now be described in relation to blocks 724-738 shown in FIG. 7B.

As shown in FIG. 7B, block 724 involves performing operations by the system to determine if the drop size for the pixel associated with the inoperative inkjet is the same as the drop size for the another pixel. If not [724:NO], then method 700 continues to block 726 where the system concludes or otherwise determines that no action is to be taken. This conclusion or determination can be made, for example, using a look up table (e.g., table 500 of FIG. 5B). If so [724:YES], then 700 continues to block 728 where the system identifies a next another pixel (e.g., pixel 440 of FIG. 4) in the bit map that is to be analyzed at this time as specified in the order defined by the displacement map.

Next in decision block 730, the system determines whether the next another pixel has the same assigned priority level as the another pixel (e.g., priority level 1). This determination may be made, for example, using a priority map A of FIG. 5 or priority map B of FIG. 6). If not [730:NO], method 700 continues to block 732 where the system continues to block 746 so that a low preference action analysis may be performed for pixels (e.g., pixels 420-424, 438-442 of FIG. 4 in the case of priority map A) of this given priority level (e.g., priority level 1). If so [730:YES], method 700 continues with block 734 where the system obtains a drop value for the next another pixel. This drop value obtained in block 734 is not set to none [736:NO], then method 700 continues to block 742 of FIG. 7C. Block 742 will be discussed below. Otherwise [736:YES], method 700 continues to block 738 where the high preference action is performed by the system to promote the drop value obtained in block 734 from none N to small S. Subsequently, method 700 ends or other operations are performed as shown by block 740. The other operations can include, but are not limited to, returning to block 704 of FIG. 7A.

Referring now to FIG. 7C, block 742 involves comparing the drop value for the pixel associated with the inoperative inkjet with the drop value of the next another pixel. If the drop size for the pixel associated with the inoperative inkjet is larger than the drop size for the next another pixel [744:YES], then the drop values are switched in block 746. Method 700 then returns to block 704 of FIG. 7A. Otherwise, method 700 continues with decision block 740.

In block 740, the system determines whether the drop values for all pixels (e.g., pixels 420-424, 438-442 of FIG. 4 in the case of priority map A) with the given priority level (e.g., priority level 1) have been analyzed during a high preference action analysis. If not [748:NO], then method 700 returns to block 728 of FIG. 7B so that the high preference action analysis is performed for a next another pixel of the given priority level (e.g., priority level 1), as shown by block 750.

Otherwise [748:YES], method 700 continues to block 752 where a low preference action analysis is started or otherwise begun by the system. The low preference action analysis may involve, for example, promoting a drop value S to L. The low preference action analysis will be described in relation to blocks 754-758 of FIG. 7C and blocks 762-776 of FIG. 7D.

As shown in FIG. 7C, block 754 involves obtaining the drop value for the first another pixel (e.g., pixel 422 of FIG. 4) in the specified order that has the given priority level (e.g., priority level 1). If the drop value obtained in block 754 is set to small [756:YES], then method 700 continues to block 758 where the system performs the low preference action to promote the drop value from S to L. Subsequently, method 700 ends or other operations are performed (e.g., return to 704) as shown by block 760.

Otherwise [756:NO], method 700 continues to block 762 of FIG. 7D where the drop value for the pixel associated with the inoperative inkjet is compared to the drop value of the another pixel. If the drop value for the pixel associated with the inoperative inkjet is not the same as the drop size for the another pixel [764:NO], then the system concludes, decides or otherwise determines that no action is to be taken in block 766. This conclusion, decision or determination can be made using, for example, an LUT. Otherwise [764:NO], method 700 continues to block 768.

Block 768 involves identifying a next another pixel (e.g., pixel 440 of FIG. 4) in the bit map that is to be analyzed at this time as specified in the order defined by the displacement map. The drop value for the next another pixel is obtained in block 770. If the drop value is set to small [772:YES], then the system performs the low preference action to promote the drop value from small to larger. Otherwise [772:NO], method 700 continues to decision block 778.

If the drop values for all the pixels of the given priority level (e.g., priority level 1) have not been analyzed during the low preference action analysis [778:NO], then method 700 returns to block 768 so that the low preference action analysis is repeated from a next another pixel of the given priority level.

Otherwise [778:YES], method 700 continues to block 782 where a next priority level is selected (e.g., priority level 2). Method 700 then returns to block 712 of FIG. 7A to repeat the process for pixels (e.g., pixels 426-430 and 444-448 of FIG. 4 in the case of priority map A) assigned to next priority level (e.g., priority level 2), as shown by block 784.

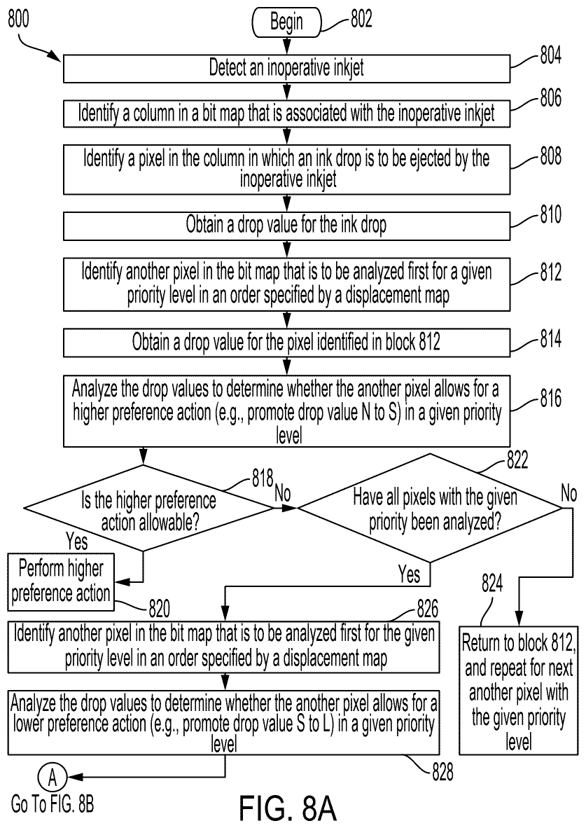

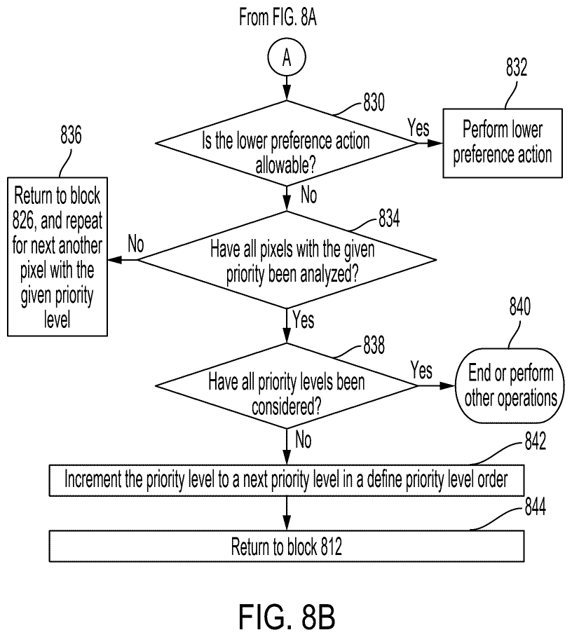

FIG. 8 provides a flow diagram of another illustrative method 800 for operating a system (e.g., system 100 of FIG. 1). The operations of the blocks in FIG. 8 may be performed in the same or different order than the order shown, and/or may include more or less operations than that shown.

Method 800 begins with 802 and continues to block 804 in which the system performs operations to detect an inoperative inkjet (e.g., inkjet 406 of FIG. 4). Any known or to be known technique for detecting an inoperative inkjet can be used here. The system then identifies a column (e.g., column 456 of FIG. 4) in a bit map (e.g., bit map 410 of FIG. 4) that is associated with the inoperative inkjet, as shown by block 806. In block 808, the system performs operations to identify a pixel (e.g., pixel 414 of FIG. 4) in the column in which an ink drop (e.g., ink drop 412 of FIG. 4) is to be ejected by the inoperative inkjet. The drop value for the pixel is obtained by the system in block 810.

In next block 812, the system identifies another pixel (e.g., pixel 422 of FIG. 4) in the bit map (e.g., bit map 410 of FIG. 4) that is to be analyzed first for a given priority level (e.g., priority level 1) in an order specified by a displacement map (e.g., displacement map 460 of FIG. 4). The drop value for the another pixel is obtained in block 814 by the system.

The drop values obtained in blocks 810, 814 are analyzed in block 816 to determine whether the another pixel allows for a high preference action (e.g., promote N to S) in a given priority level. If so [818:YES], then the high priority action is performed by the system in block 820. Thereafter, method 800 may end or other operations may be performed (e.g., return to block 802). Otherwise [818:NO], method 800 continues to decision block 822 where the system checks or determines whether all pixels (e.g., pixels 420-424, 438-442 of FIG. 4 in the case of priority map A) with the given priority level (e.g., priority level 1) have been analyzed. If not [822:NO], method 800 returns to block 812 so that the process may be repeated for a next another pixel (e.g., pixel 440 of FIG. 4) with the given priority level (e.g., priority level 1).

If all pixels with the given priority level have been analyzed to determine whether they allow for a high preference action [822:YES], method 800 continues to block 826. Block 826 involves performing operations by the system to identify another pixel (e.g., pixel 422 of FIG. 4) in the bit map that is to be analyzed first for the given priority level (e.g., priority level 1) in an order specified by the displacement map. The drop values are analyzed by the system in block 828 to determine whether the another pixel allows for a low preference action (e.g., promote a drop value S to L) in the given priority level. Upon completing the operations of block 828, method 800 continues to block 830 of FIG. 8B.

As shown in FIG. 8B, block 830 involves performing operations by the system to determine whether the low preference action is allowable. If so [830:YES], then the lower preference action is performed by the system in block 832. Otherwise [830:NO], the system checks or determines whether all pixels (e.g., pixels 420-424, 438-442 of FIG. 4 in the case of priority map A) with the given priority level (e.g., priority level 1) have been analyzed. If not [836:NO], then method 800 returns to block 826 so that the lower preference action analysis can be repeated for a next another pixel with the given priority level. Otherwise, method 800 continues to block 838 in which a check or a determination is made as to whether all priority levels (e.g., priority levels 1-3 of FIG. 5 or 1-6 of FIG. 6) have been considered. If so [838:YES], method 800 ends or other operations are performed (e.g., return to block 802) as shown by block 840. If not [838:NO], method 800 continues to block 842 where the priority level is incremented to a next priority level (e.g., priority level 2) in the defined priority level order. Method 800 then return to block 812 as shown by block 844.

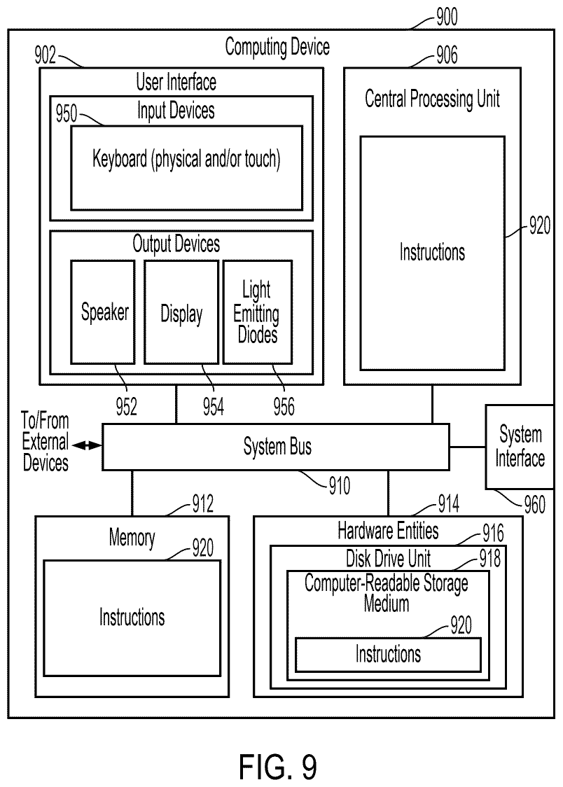

Referring now to FIG. 9, there is shown an illustrative architecture for a computing device 900. Controller 170 of FIG. 1 is/are the same as or similar to computing device 900. As such, the discussion of computing device 900 is sufficient for understanding the controller 170 of FIG. 1.

Computing device 900 may include more or less components than those shown in FIG. 9. However, the components shown are sufficient to disclose an illustrative solution implementing the present solution. The hardware architecture of FIG. 9 represents one implementation of a representative computing device configured to receive information, process the receive information, transmit information and/or control operations of an aerial vehicle, as described herein. As such, the computing device 900 of FIG. 9 implements at least a portion of the method(s) described herein.

Some or all components of the computing device 900 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 9, the computing device 900 comprises a user interface 902, a Central Processing Unit (CPU) 906, a system bus 910, a memory 912 connected to and accessible by other portions of computing device 900 through system bus 910, a system interface 960, and hardware entities 914 connected to system bus 910. The user interface can include input devices and output devices, which facilitate user-software interactions for controlling operations of the computing device 900. The input devices include, but are not limited to, a physical and/or touch keyboard 950. The input devices can be connected to the computing device 900 via a wired or wireless connection (e.g., a Bluetooth® connection). The output devices include, but are not limited to, a speaker 952, a display 954, and/or light emitting diodes 956. System interface 960 is configured to facilitate wired or wireless communications to and from external devices (e.g., network nodes such as access points, etc.).

At least some of the hardware entities 914 perform actions involving access to and use of memory 912, which can be a Random Access Memory (RAM), a disk drive, flash memory, a Compact Disc Read Only Memory (CD-ROM) and/or another hardware device that is capable of storing instructions and data. Hardware entities 914 can include a disk drive unit 9816 comprising a computer-readable storage medium 918 on which is stored one or more sets of instructions 920 (e.g., software code) configured to implement one or more of the methodologies, procedures, or functions described herein. The instructions 920 can also reside, completely or at least partially, within the memory 912 and/or within the CPU 906 during execution thereof by the computing device 900. The memory 912 and the CPU 906 also can constitute machine-readable media. The term “machine-readable media”, as used here, refers to a single medium or multiple media (e.g., a centralized or distributed database, and/or associated caches and servers) that store the one or more sets of instructions 920. The term “machine-readable media”, as used here, also refers to any medium that is capable of storing, encoding or carrying a set of instructions 920 for execution by the computing device 900 and that cause the computing device 900 to perform any one or more of the methodologies of the present disclosure.

In view of the forgoing, the present solution concerns implementing systems and methods for operating a printing system (e.g., printing system 100 of FIG. 1). The methods comprise: identifying, by the processor (e.g., controller 170 of FIG. 1 and/or CPU 906 of FIG. 9), a pixel in a bit map in which an ink drop is to be ejected by an inoperative inkjet during printing operations (wherein the pixel is associated with a first drop value); identifying, by the processor, other pixels in the bit map that are to be analyzed at the present time in accordance with a pixel order defined by a displacement map (wherein each of the other pixels are associated with a second drop value); performing a higher preference action analysis of only first ones of the plurality of pixels assigned a given priority level of a plurality of different priority levels defined by a priority map to determine whether a higher preference action is allowable based on the first and second drop values; and performing a lower preference action analysis of only the first ones of the plurality of pixels to determine whether a lower preference action is allowable based on the first and second drop values, when a determination is made that higher preference action is not allowable.

The methods may also comprise performing the higher preference action to promote a drop value specifying that no ink drop is to be ejected to a drop value specifying that an ink drop of a first ink drop size is to be ejected, when a determination is made that the higher preference action is allowable. The first ones of the plurality of pixels may be analyzed during the high preference action analysis in accordance with the pixel order defined by the displacement map.

The methods may further comprise performing the lower preference action to promote a drop value specifying that an ink drop of a smaller ink drop size is to be ejected to a drop value specifying that an ink drop of a larger ink drop size is to be ejected, when a determination is made that the higher preference action is not allowable and the lower preference action is allowable. The lower preference action analysis is performed when none of the second drop values specify that no ink drop is to be ejected. The first ones of the plurality of pixels are analyzed during the higher preference action analysis in accordance with the pixel order defined by the displacement map and are re-analyzed during the lower preference action analysis in accordance with the pixel order defined by the displacement map.

The methods may comprise using the priority map in addition to the displacement map during said identifying to identify the other pixels having the given priority level assigned thereto. The priority map specifies priority level assignments for each of the plurality of pixels, at least two of the plurality of pixels being assigned to each of the plurality of different priority levels and the plurality of different priority levels comprising two or more different priority levels.

The method may comprise comparing the first drop value to one of the second drop values, and swapping the first and second drop values when the ink drop size associated with the first pixel is larger than an ink drop size associated with the one of the second drop values. The higher preference analysis is performed when the ink drop size associated with the first pixel is not larger than an ink drop size associated with the one of the second drop values.

The methods may comprise: identifying next other pixels in the bit map that are to be analyzed subsequent to the other pixels in accordance with the pixel order defined by the displacement map, the next other pixels being associated with third drop values and having an assigned priority level different than the given priority level; and repeating at least one of the high preference action analysis and low preference action analysis using the third drop values associated with the next other pixels, when each the second drop values for all of the first ones of the plurality of pixels specifies an ink drop size larger than the first ink drop size specified by the first drop value.

The present document also concerns systems comprising: a processor; and a non-transitory computer-readable medium comprising one or more programming instructions that when executed by the processor, cause the processor to: identify a pixel in a bit map in which an ink drop is to be ejected by an inoperative inkjet during printing operations, the pixel being associated with a first drop value; identify other pixels in the bit map that are to be analyzed at the present time in accordance with a pixel order defined by a displacement map, each of the other pixels being associated with a second drop value; perform a higher preference action analysis of only first ones of the plurality of pixels assigned a given priority level of a plurality of different priority levels defined by a priority map to determine whether a higher preference action is allowable based on the first and second drop values; and perform a lower preference action analysis of only the first ones of the plurality of pixels to determine whether a lower preference action is allowable based on the first and second drop values, when a determination is made that higher preference action is not allowable.

The processor may be further caused to perform the higher preference action to promote a drop value specifying that no ink drop is to be ejected to a drop value specifying that an ink drop of a first ink drop size is to be ejected, when a determination is made that the higher preference action is allowable. The first ones of the plurality of pixels are analyzed during the high preference action analysis in accordance with the pixel order defined by the displacement map.

The processor may be further caused to perform the lower preference action to promote a drop value specifying that an ink drop of a smaller ink drop size is to be ejected to a drop value specifying that an ink drop of a larger ink drop size is to be ejected, when a determination is made that the higher preference action is not allowable and the lower preference action is allowable. The lower preference action analysis is performed when none of the second drop values specify that no ink drop is to be ejected. The first ones of the plurality of pixels are analyzed during the higher preference action analysis in accordance with the pixel order defined by the displacement map and are re-analyzed during the lower preference action analysis in accordance with the pixel order defined by the displacement map.

The processor may be further caused to use the priority map in addition to the displacement map during said identifying to identify the other pixels having the given priority level assigned thereto. The priority map specifies priority level assignments for each of the plurality of pixels, at least two of the plurality of pixels being assigned to each of the plurality of different priority levels and the plurality of different priority levels comprising two or more different priority levels.

The present document also concerns systems comprising: printheads configured to apply ink marks to a sheet of media; and a processor. The processor is configured to: identify a pixel in a bit map in which an ink drop is to be ejected by an inoperative inkjet of the printheads on the sheet of media during printing operations, the pixel being associated with a first drop value; identify other pixels in the bit map that are to be analyzed at the present time in accordance with a pixel order defined by a displacement map, each of the other pixels being associated with a second drop value; perform a higher preference action analysis of only first ones of the plurality of pixels assigned a given priority level of a plurality of different priority levels defined by a priority map to determine whether a higher preference action is allowable based on the first and second drop values; and perform a lower preference action analysis of only the first ones of the plurality of pixels to determine whether a lower preference action is allowable based on the first and second drop values, when a determination is made that higher preference action is not allowable.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A method for operating a printing system, comprising:
identifying, by the processor, a pixel in a bit map in which an ink drop is to be ejected by an inoperative inkjet during printing operations, the pixel being associated with a first drop value;
identifying, by the processor, other pixels in the bit map that are to be analyzed at the present time in accordance with a pixel order defined by a displacement map, each of the other pixels being associated with a second drop value;
performing a higher preference action analysis of only first ones of the plurality of pixels assigned a given priority level of a plurality of different priority levels defined by a priority map to determine whether a higher preference action is allowable based on the first and second drop values; and
performing a lower preference action analysis of only the first ones of the plurality of pixels to determine whether a lower preference action is allowable based on the first and second drop values, when a determination is made that higher preference action is not allowable.

2. The method according to claim 1, further comprising performing the higher preference action to promote a drop value specifying that no ink drop is to be ejected to a drop value specifying that an ink drop of a first ink drop size is to be ejected, when a determination is made that the higher preference action is allowable.

3. The method according to claim 2, wherein the first ones of the plurality of pixels are analyzed during the high preference action analysis in accordance with the pixel order defined by the displacement map.

4. The method according to claim 1, further comprising performing the lower preference action to promote a drop value specifying that an ink drop of a smaller ink drop size is to be ejected to a drop value specifying that an ink drop of a larger ink drop size is to be ejected, when a determination is made that the higher preference action is not allowable and the lower preference action is allowable.

5. The method according to claim 1, wherein the lower preference action analysis is performed when none of the second drop values specify that no ink drop is to be ejected.

6. The method according to claim 1, wherein the first ones of the plurality of pixels are analyzed during the higher preference action analysis in accordance with the pixel order defined by the displacement map and are re-analyzed during the lower preference action analysis in accordance with the pixel order defined by the displacement map.

7. The method according to claim 1, further comprising using the priority map in addition to the displacement map during said identifying to identify the other pixels having the given priority level assigned thereto.

8. The method according to claim 1, wherein the priority map specifies priority level assignments for each of the plurality of pixels, at least two of the plurality of pixels being assigned to each of the plurality of different priority levels and the plurality of different priority levels comprising two or more different priority levels.

9. The method according to claim 1, further comprising comparing the first drop value to one of the second drop values, and swapping the first and second drop values when the ink drop size associated with the first pixel is larger than an ink drop size associated with the one of the second drop values.

10. The method according to claim 10, wherein the higher preference analysis is performed when the ink drop size associated with the first pixel is not larger than an ink drop size associated with the one of the second drop values.

11. The method according to claim 1, further comprising:
identifying next other pixels in the bit map that are to be analyzed subsequent to the other pixels in accordance with the pixel order defined by the displacement map, the next other pixels being associated with third drop values and having an assigned priority level different than the given priority level; and
repeating at least one of the high preference action analysis and low preference action analysis using the third drop values associated with the next other pixels, when each the second drop values for all of the first ones of the plurality of pixels specifies an ink drop size larger than the first ink drop size specified by the first drop value.

12. A system, comprising:
a processor; and
a non-transitory computer-readable medium comprising one or more programming instructions that when executed by the processor, cause the processor to:
identify a pixel in a bit map in which an ink drop is to be ejected by an inoperative inkjet during printing operations, the pixel being associated with a first drop value;
identify other pixels in the bit map that are to be analyzed at the present time in accordance with a pixel order defined by a displacement map, each of the other pixels being associated with a second drop value;
perform a higher preference action analysis of only first ones of the plurality of pixels assigned a given priority level of a plurality of different priority levels defined by a priority map to determine whether a higher preference action is allowable based on the first and second drop values; and
perform a lower preference action analysis of only the first ones of the plurality of pixels to determine whether a lower preference action is allowable based on the first and second drop values, when a determination is made that higher preference action is not allowable.

13. The system according to claim 12, wherein the processor is further caused to perform the higher preference action to promote a drop value specifying that no ink drop is to be ejected to a drop value specifying that an ink drop of a first ink drop size is to be ejected, when a determination is made that the higher preference action is allowable.

14. The system according to claim 13, wherein the first ones of the plurality of pixels are analyzed during the high preference action analysis in accordance with the pixel order defined by the displacement map.

15. The system according to claim 12, wherein the processor is further caused to perform the lower preference action to promote a drop value specifying that an ink drop of a smaller ink drop size is to be ejected to a drop value specifying that an ink drop of a larger ink drop size is to be ejected, when a determination is made that the higher preference action is not allowable and the lower preference action is allowable.

16. The system according to claim 12, wherein the lower preference action analysis is performed when none of the second drop values specify that no ink drop is to be ejected.

17. The system according to claim 12, wherein the first ones of the plurality of pixels are analyzed during the higher preference action analysis in accordance with the pixel order defined by the displacement map and are re-analyzed during the lower preference action analysis in accordance with the pixel order defined by the displacement map.

18. The system according to claim 12, wherein the processor is further caused to use the priority map in addition to the displacement map during said identifying to identify the other pixels having the given priority level assigned thereto.

19. The system according to claim 12, wherein the priority map specifies priority level assignments for each of the plurality of pixels, at least two of the plurality of pixels being assigned to each of the plurality of different priority levels and the plurality of different priority levels comprising two or more different priority levels.

20. A system, comprising:
printheads configured to apply ink marks to a sheet of media; and
a processor configured to:
identify a pixel in a bit map in which an ink drop is to be ejected by an inoperative inkjet of the printheads on the sheet of media during printing operations, the pixel being associated with a first drop value;
identify other pixels in the bit map that are to be analyzed at the present time in accordance with a pixel order defined by a displacement map, each of the other pixels being associated with a second drop value;
perform a higher preference action analysis of only first ones of the plurality of pixels assigned a given priority level of a plurality of different priority levels defined by a priority map to determine whether a higher preference action is allowable based on the first and second drop values; and
perform a lower preference action analysis of only the first ones of the plurality of pixels to determine whether a lower preference action is allowable based on the first and second drop values, when a determination is made that higher preference action is not allowable.
